(19) United States
(12) Patent Application Publication
(10) Pub. No.: US 2008/0282559 A1
(43) Pub. Date: Nov. 20, 2008

(54) PENCIL SHARPENER

(76) Inventor: Hui-Yih HUNG, Tainan City (TW)

Correspondence Address: SHERIDAN ROSS PC, 1560 BROADWAY, SUITE 1200, DENVER, CO, 80202, US

(21) Appl. No.: 11/748,960

(22) Filed: May 15, 2007

(51) Int. Cl. B43L 23/00

(52) U.S. Cl. 30/457

(57) ABSTRACT

A pencil sharpener includes a sharpener body, a blade mounting member which is fitted to a distal surrounding wall of the sharpener body and which has a seat end wall with a slot to form an insertion path, a blade which is disposed in the slot, a tubular grip member which is fitted in an insertion hole and which is movable between non-working and working positions to be remote from and close to the seat end wall, respectively. The grip member has an inner peripheral grip surface which defines a passage to be communicated with the slot and which is brought into engagement with a lead-side end of a pencil barrel to permit a lead of the pencil to be placed in the insertion path once the grip member is displaced to the working position. A biasing member is disposed to bias the grip member to the non-working position.

### BACKGROUND OF THE INVENTION

1. Field of the Invention

This invention relates to a pencil sharpener, more particularly to a pencil sharpener for sharpening a lead of a pencil.

2. Description of the Related Art

Referring to FIGS. 1 and 2, a conventional pencil sharpener 1 is shown to be placed on a writing implement 2. The writing implement 2 includes a barrel 21, a clip 22 disposed on a top end of the barrel 21, and a head 23 screwed to the barrel 21 to be a lead-side end for holding and exposing a lead 24. The clip 22 has an upwardly extending holding portion 221. The sharpener 1 includes a blade mounting seat 11, a blade 12 secured to the blade mounting seat 11, and an end cap 13 removably mounted on the blade mounting seat 11. The blade mounting seat 11 has a base wall 111 with a center hole 114, a surrounding sleeve wall 112 extending from the base wall 111 to be sleeved on the holding portion 221 of the clip 22, and a blade mounting wall 113 opposite to the surrounding sleeve wall 112. The blade 12 is disposed in the blade mounting wall 113, and has a straight edge 122 and a slanting cutting edge 123 which cooperatively define a cutting portion 121.

In use, the sharpener 1 is removed from the holding portion 221 (as indicated by dotted lines shown in FIG. 2) to permit the surrounding sleeve wall 112 to be sleeved on the head 23. The lead 24 is inserted into the cutting portion 121 through the center hole 114, and is rotated so as to be sharpened by the blade 12.

Preferably, the exposed portion of the lead 24 has a length of about 6.5 mm, and is formed with a sharpened segment of about 5 mm. The surrounding sleeve wall 112 is configured to be sleeved on the holding portion 221 and the head 23. Hence, once the exposed portion of the lead 24 has a length less than 6.5 mm, the lead 24 may not be inserted into the cutting portion 121 of the blade 12, and cannot be sharpened thereby. On the contrary, once the exposed portion of the lead 24 has a length greater than 6.5 mm, the head 23 may not be held by the surrounding sleeve wall 112 such that slanting of a cutting angle of the lead 24 occurs.

### SUMMARY OF THE INVENTION

The object of the present invention is to provide a pencil sharpener which can hold a pencil steadily during a sharpening action so as to achieve a uniform sharpening effect.

According to this invention, the pencil sharpener includes a sharpener body which has proximate and distal surrounding walls opposite to each other along a longitudinal axis, and an accommodation chamber interposed therebetween. The proximate surrounding wall defines an insertion hole communicated with the accommodation chamber. A blade mounting member has a base which is fitted to the distal surrounding wall, and a seat end wall which extends from the base towards the proximate surrounding wall and which has a slot extending along the longitudinal axis to form an insertion path. At least one blade is disposed in the slot for sharpening a lead of a pencil that is brought into the slot along the insertion path. A tubular grip member is fitted in the insertion hole, and is movable between a non-working position, where the grip member is remote from the seat end wall, and a working position, where the grip member is close to the seat end wall so as to permit the lead to be placed in the insertion path. The grip member has an access opening which is disposed opposite to the slot along the longitudinal axis, and an inner peripheral grip surface which defines a passage that extends along the longitudinal axis through the grip member to communicate the access opening with the slot. The inner peripheral grip surface is configured such that when the lead is led through the passage, the inner peripheral grip surface is brought into engagement with a lead-side end of the pencil barrel so as to permit the lead to be placed in the insertion path once the grip member is displaced to the working position. A biasing member is disposed to bias the grip member from the working position to the non-working position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary exploded perspective view of a conventional pencil sharpener;

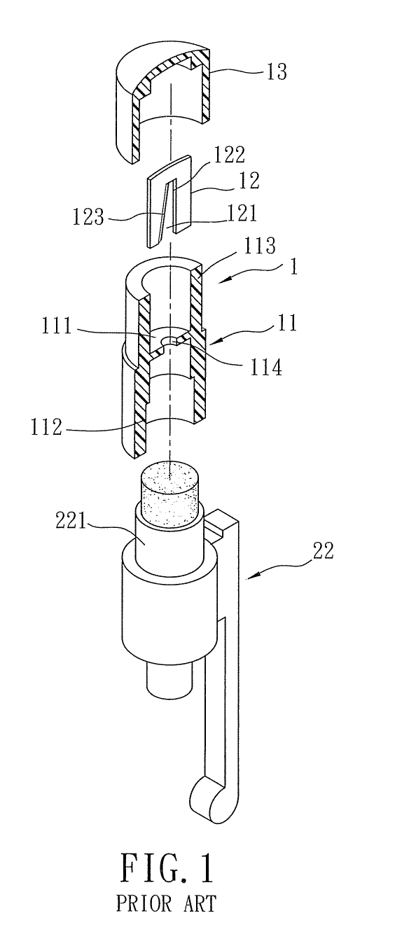

FIG. 2 is a fragmentary sectional view of the conventional pencil sharpener;

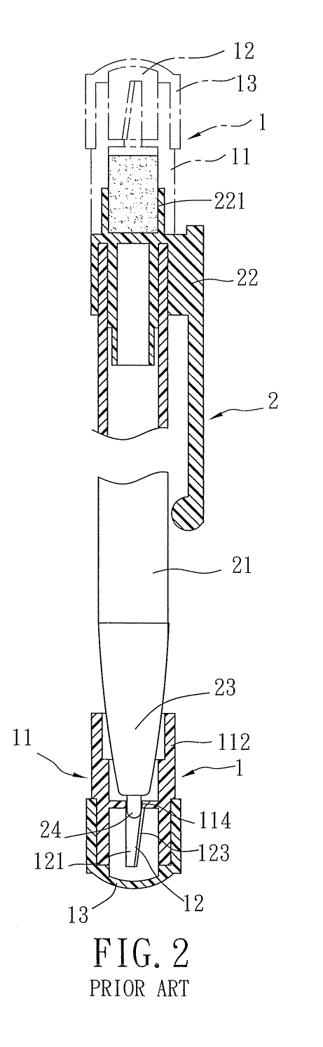

FIG. 3 is an exploded perspective view of the preferred embodiment of a pencil sharpener according to this invention;

FIG. 4 is a sectional view of the preferred embodiment in a non-working state;

FIG. 5 is a sectional view of the preferred embodiment after insertion of a lead of a pencil;

FIG. 6 is a sectional view of the preferred embodiment in a working state;

FIG. 7 is an exploded view of another preferred embodiment of a pencil sharpener according to this invention.

### DETAILED DESCRIPTION OF THE PREFERRED EMBODIMENTS

Before the present invention is described in greater detail, it should be noted that same reference numerals have been used to denote like elements throughout the specification.

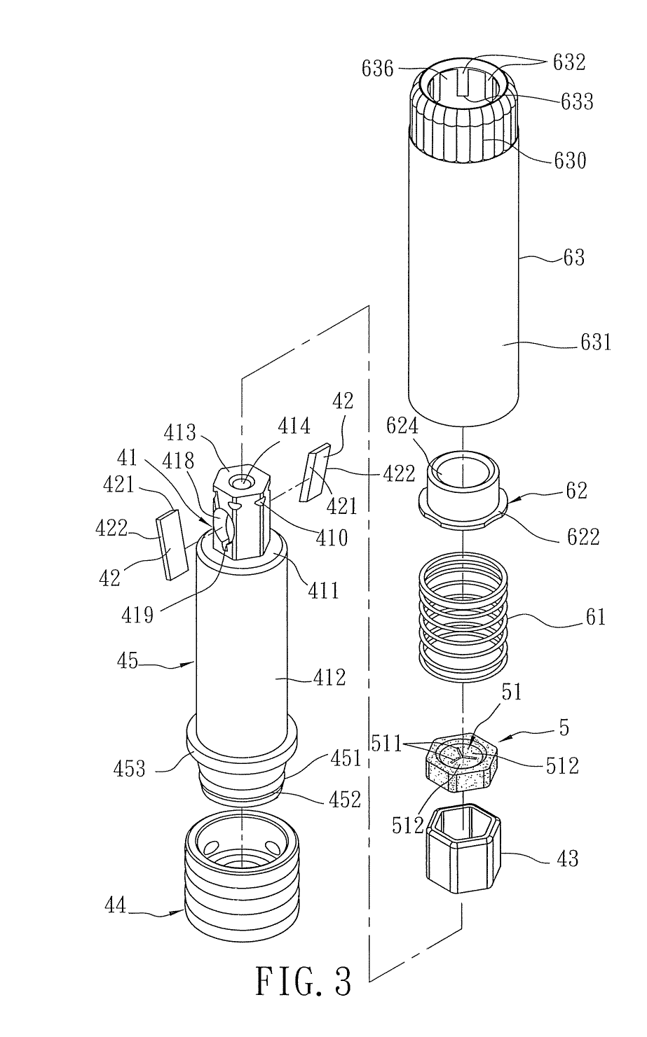

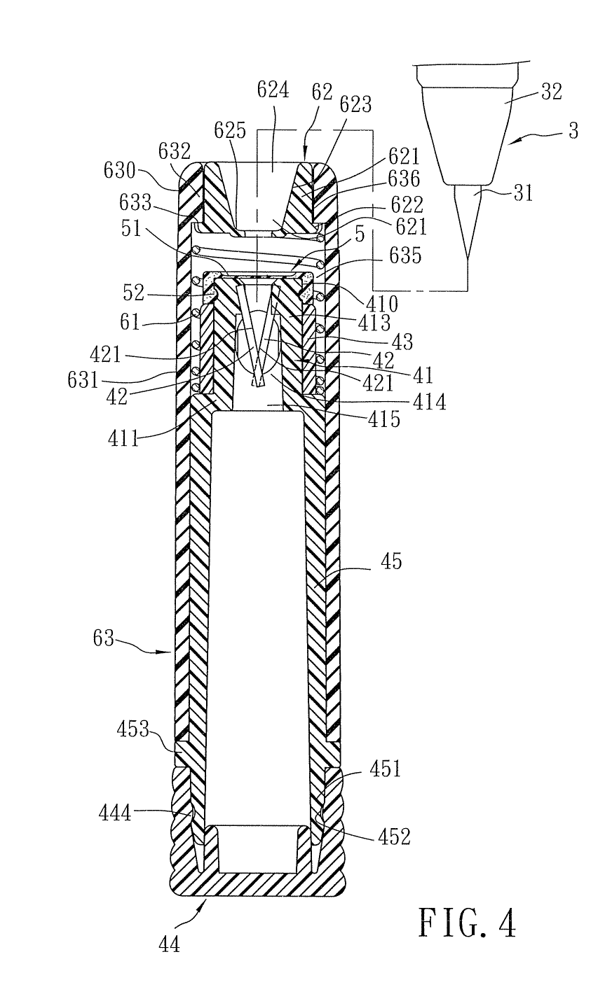

Referring to FIGS. 3 and 4, the preferred embodiment of a pencil sharpener according to the present invention is shown to be used for sharpening a lead 31 of a writing implement, such as a pencil 3. The pencil sharpener of this embodiment is shown to comprise a sharpener body 63, a blade mounting member 41, a pair of blades 42, a receptacle 45, an end cap 44, a dust preventive member 5, a tubular grip member 62, and a biasing member 61.

The sharpener body 63 includes proximate and distal surrounding walls 630, 631 which are opposite to each other along a longitudinal axis, and an accommodation chamber 635 interposed therebetween. The proximate surrounding wall 630 defines an insertion hole 636 which is communicated with the accommodation chamber 635. A plurality of protrusions 632 are disposed on an inner surface of the proximate surrounding wall 630, and extend towards the distal surrounding wall 631 to terminate at a plurality of abutment surfaces 633.

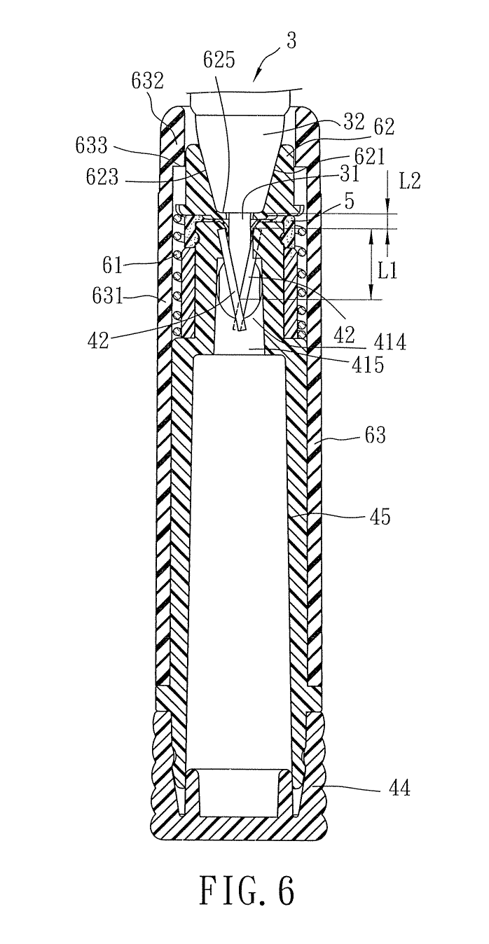

The blade mounting member 41 has a base 411 which is fitted to an inner surface of the distal surrounding wall 631, and a tubular seat end wall 413 which extends from the base 411 towards the proximate surrounding wall 630 and which has a slot 414 that extends along the longitudinal axis to form an insertion path. The seat end wall 413 has an outer peripheral wall surface which surrounds the longitudinal axis, and which has a through hole 418 that extends radially to be communicated with the slot 414, a pair of blade mounting grooves 419 that extend radially to be communicated with the slot 414 and that intersect at the through hole 418. Each of the blades 42 has an insert portion 422 which is received in the respective blade mounting groove 419, and a cutting edge 421 which is opposite to the insert portion 422 and which extends into the slot 414. A sleeve 43 is sleeved on the outer peripheral wall surface of the seat end wall 413 to retain the blades 42 to the seat end wall 413. Thus, the blades 42 are detachably mounted to the blade mounting member 41 for replacement. When the lead 31 of the pencil 3 is brought into the slot 414 along the insertion path, a subsequent rotation of the lead 31 about the longitudinal axis will bring about a sharpening action of the blades 42 on the lead 31, as shown in FIG. 6.

The base 411 of the blade mounting member 41 has a discharging port 415 which extends along the longitudinal axis to be communicated with the slot 414. The receptacle 45 is disposed downstream of the discharging port 415 to accommodate dust generated as a result of the sharpening action of the blades 42. In this embodiment, the receptacle 45 is integrally formed with and extends from the base 411 opposite to the seat end wall 413. The receptacle 45 has an opened end 451 opposite to the discharging port 415. The end cap 44 is detachably mounted on the opened end 451 to cover the receptacle 45 by engagement between an annular protrusion 444 of the end cap 44 and an annular groove 452 in the receptacle 45. An abutting ring 453 is disposed on the receptacle 45 adjacent to the opened end 451, and abuts against the distal surrounding wall 631 of the sharpener body 63.

The dust preventive member 5 has a flexible sheet 51 which is mounted on the seat end wall 413 and which extends radially relative to the longitudinal axis by engagement between an annular protrusion 52 and an annular groove 410 so as to cover the slot 414. The flexible sheet 51 has a plurality of slits 511 which extend radially and towards the longitudinal axis to form a plurality of pliable sections 512 such that the pliable sections 512 yield to the placement of the lead 31 in the insertion path.

The grip member 62 is configured to be fitted in the insertion hole 636 in the proximate surrounding wall 630, and is movable between a non-working position, as shown in FIG. 4, where the grip member 62 is remote from the seat end wall 413, and a working position, as shown in FIG. 6, where the grip member 62 is close to the seat end wall 413 so as to permit the lead 31 of the pencil 3 to be placed in the slot 414. The grip member 62 has an access opening 624 which is disposed opposite to the slot 414 along the longitudinal axis, and an inner peripheral grip surface 623 which is of a frustoconical shape and which defines a passage 621 that extends along the longitudinal axis through the grip member 62 to communicate the access opening 624 with the slot 414 and that terminates at an annular abutment 625. The grip member 62 has a surrounding flange 622 which is disposed to abut against the abutment surfaces 633 when the grip member 62 is in the non-working position. The biasing member 61 is disposed in the accommodation chamber 635 and has two ends which are opposite to each other along the longitudinal axis and which abut against the grip member 62 and the base 411, respectively to bias the surrounding flange 622 to abut against the abutment surfaces 633 so as to bias the grip member 62 to the non-working position.

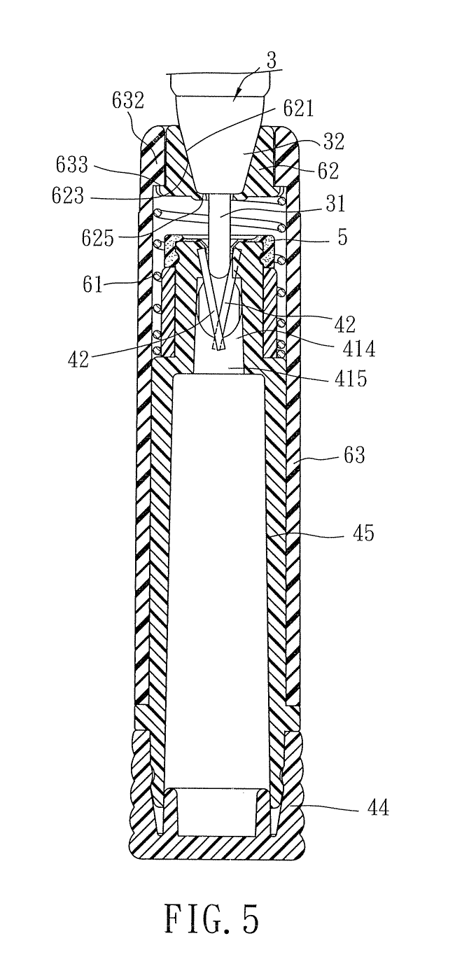

As shown in FIGS. 3 and 5, in use, firstly, the lead-side end 32 of the pencil 3 is inserted into the passage 621 to be engaged with the inner peripheral grip surface 623 and to abut against the annular abutment 625. At the same time, the lead 31 passes through the dust preventive member 5. Subsequently, as shown in FIG. 6, the user presses the pencil 3 against the biasing action of the biasing member 61 to cause the grip member 62 to displace to the working position, and to permit the lead 31 to be placed in the insertion path. A subsequent rotation of the pencil 3 about the longitudinal axis will bring about a sharpening action of the blades 42 on the lead 31. Moreover, dust generated as a result of the sharpening action will fall and is collected in the receptacle 45. Once the grip member 62 abuts against the dust preventive member 5, the sharpening operation is completed.

Preferably, a distance (L1) between the intersecting point of the blades 42 and an upper edge of each blade 42 is about 5 mm, and a distance (L2) between the upper edge of each blade 42 and the annular abutment 625 is about 1.5 mm. During sharpening, the lead 31 can be retained steadily to extend along the insertion path by the grip member 62 and the seat end wall 41 and by virtue of the biasing action of the biasing member 61. Thus, the lead 31 can be made to have a length of 6.5 mm, and the sharpened segment thereof has a length of 5 mm.

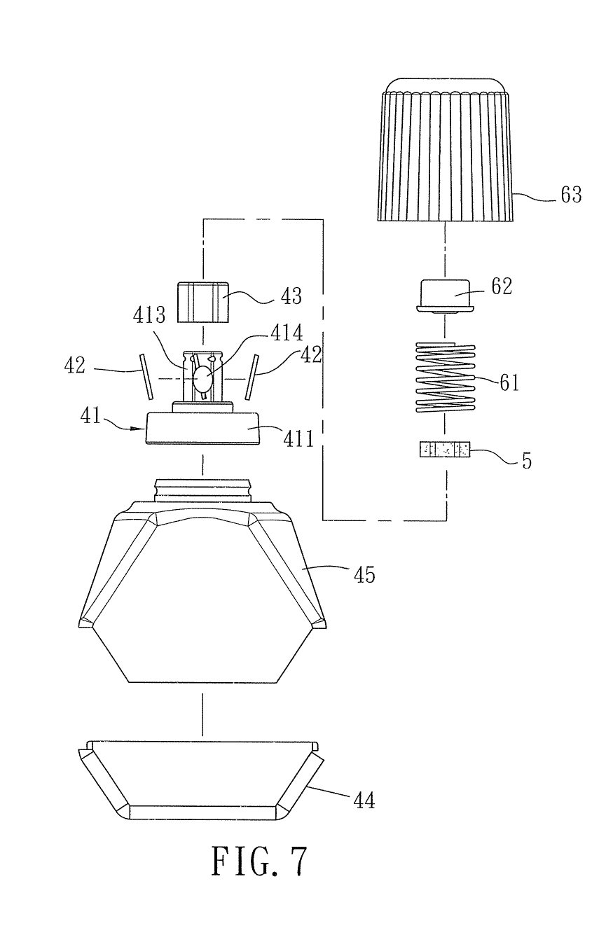

Referring to FIG. 7, another preferred embodiment of the pencil sharpener according to this invention is shown to be similar to the previous embodiment in construction, expect that the blade mounting member 41 and the receptacle 45 are two separate parts, and are connected to each other by virtue of a threaded engagement.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A pencil sharpener for sharpening a lead of a pencil which includes a barrel having a lead-side end for holding and exposing the lead, comprising:
a sharpener body including proximate and distal surrounding walls which are opposite to each other along a longitudinal axis, and an accommodation chamber interposed therebetween, said proximate surrounding wall defining an insertion hole which is communicated with said accommodation chamber;
a blade mounting member which has a base that is fitted to said distal surrounding wall, and a seat end wall that extends from said base towards said proximate surrounding wall and that has a slot extending along the longitudinal axis to form an insertion path;
at least one blade which is disposed in said slot such that once the lead is brought into said slot along said insertion path, a subsequent rotation of the lead about the longitudinal axis will bring about a sharpening action of said blade on the lead;
a tubular grip member which is configured to be fitted in said insertion hole and which is disposed to be movable between a non-working position, where said grip member is remote from said seat end wall, and a working position, where said grip member is close to said seat end wall so as to permit the lead to be placed in said insertion path, said grip member having an access opening which is disposed opposite to said slot along the longitudinal axis, and an inner peripheral grip surface which defines a passage that extends along the longitudinal axis through said grip member to communicate said access opening with said slot, said inner peripheral grip surface being configured such that when the lead is led through said passage, said inner peripheral grip surface is brought into engagement with the lead-side end of the barrel so as to permit the lead to be placed in said insertion path once said grip member is displaced to the working position; and
a biasing member disposed to bias said grip member from the working position to the non-working position.

2. The pencil sharpener of claim 1, wherein said base of said blade mounting member has a discharging port which extends along the longitudinal axis to be communicated with said insertion path, said pencil sharpener further comprising a receptacle which is disposed downstream of said discharging port to accommodate dust generated as a result of the sharpening action of said blade.

3. The pencil sharpener of claim 2, wherein said receptacle is mounted to said blade mounting member by virtue of a threaded engagement.

4. The pencil sharpener of claim 2, wherein said receptacle has an opened end opposite to said discharging port, said pencil sharpener further comprising an end cap which is detachably mounted on said opened end to cover said receptacle.

5. The pencil sharpener of claim 1, further comprising a dust preventive member which has a flexible sheet that is mounted on said seat end wall and that extends radially relative to the longitudinal axis to interrupt communication of said slot with said passage, said flexible sheet having a plurality of slits which extend radially and towards the longitudinal axis to form a plurality of pliable sections such that said pliable sections yield to the placement of the lead in said insertion path.

6. The pencil sharpener of claim 1, wherein said sharpener body has a protrusion which is disposed on said proximate surrounding wall and which extends towards said seat end wall to terminate at an abutment surface, said grip member having a surrounding flange which is disposed to abut against said abutment surface when said grip member is in the non-working position, said biasing member being disposed in said accommodation chamber and having two ends that are opposite to each other along the longitudinal axis and that abut against said grip member and said base, respectively so as to bias said surrounding flange to abut against said abutment surface.

7. The pencil sharpener of claim 1, wherein said inner peripheral grip surface of said grip member is of a frustoconical shape.

8. The pencil sharpener of claim 1, wherein said seat end wall has an outer peripheral wall surface which surrounds the longitudinal axis, and which has at least one groove that extends radially to be communicated with said slot, said blade having an insert portion which is received in said blade mounting groove, and a cutting edge which is opposite to said insert portion and which extends into said slot, said pencil sharpener further comprising a sleeve which is sleeved on said outer peripheral wall surface to retain said blade to said blade mounting member.
